(19) United States
(12) Patent Application Publication
(10) Pub. No.: US 2009/0249781 A1
(43) Pub. Date: Oct. 8, 2009

(54) System and method of increasing the output energy of a motor by transferring the output energy through a plurality of hydraulic networks

(76) Inventor: Ed Gilbert, JR., (US)

Correspondence Address: ED GILBERT JR., 431 SILVERLEAF LANE, DALLAS, GA, 30157, US

(21) Appl. No.: 12/061,471

(22) Filed: Apr. 2, 2008

(51) Int. Cl. F15B 7/00

(52) U.S. Cl. 60/536; 60/581

(57) ABSTRACT

Today, the world is faced with many problems such as the Greenhouse Effect, global warming, ozone layer depletion and increased pollution. One direct cause of these problems has been linked to the emission from internal combustion engines.

One way to combat these problems is to create a system which utilizes a small internal combustion engine or electrical motor coupled with a hydraulic network. The hydraulic network will exponentially increase output energy without raising the emission levels. In the case where an electrical motor is being used, there is a complete void of pollutants.

This motor/hydraulic coupling not only helps save the environment, but provides a cost-effective means of power.

### BACKGROUND OF THE INVENTION

1. Field of the Invention

This invention relates generally to a motor coupled to a plurality of hydraulic networks of increasing size to increase the overall output energy of the motor being utilized. The final output energy is utilized as the primary source to drive a motor-vehicle.

2. Description of the Related Technology

Hydraulics have been used for years to do work where normal mean of power fall short. Hydraulics have been used as wheel motors in track vehicles and farm machinery, but these systems only provide a slow mean of movement and are not suited for commercial use as in automobiles. Prior art, such as U.S. Pat. No. 386,116 and U.S. Pat. No. 3,938,332 where there is only a transference of energy will not work in an automobile due to the extreme load that would be placed on the system to create motion. Also, the prior arts would be too bulky, if some how implemented for automobile applications. The present art solves these variables by being exponentially increasing output energy and compact.

### SUMMARY OF THE INVENTION

The present invention provides a primary drive system for a vehicle. In a preferred embodiment, the system comprises of a motor coupled with a plurality of hydraulic networks of increasing size (pistons, vanes, etc.). The motor is directly or indirect mounted to a rotational mechanism contained within the makeup of the hydraulic networks. The rotational mechanisms contain piston or vanes, etc. to do work on the fluid within the system. In the preferred embodiment, a crankshaft/pistons/rods combination is being used, whereas the rotational angles of the crankshafts are consistent throughout the networks and the stroke decreases outward from the input source. The crankshaft/pistons/rods combinations are configured in such manner as to create rotation of the crankshafts when the fluid within the system is supplied a force from the rotation of the motor. As the motor rotates the crankshaft of the primary hydraulic network, at a given revolutions per minute (rpm), the pistons pushes fluid at a +/−1 to 1 ratio into the next hydraulic system of increased size at the same rpm causing rotation of the secondary crankshaft, in turn, pushing fluid back to the primary hydraulic network. Due to the laws of physics, the output energy of the secondary hydraulic system will be exponentially greater than the output energy of the primary, due to the increase in size of the system.

A system and method of this nature is suitable for automotive applications because the final output energy is far greater than input energy and the energy needed to substance thereof. Example: An electric motor exerts a 2 pound force @30 amps max. Electrical input, on the fluid in a 1 inch cylinder; that energy is transferred to another cylinder with a 10 inch diameter piston, the final output energy will be 200 pounds of force. In turn, this amount of force can provide enough force to turn high output generators or alternators to sustain almost any electrical requirements.

### BRIEF DESCRIPTION OF DRAWINGS

FIG. 1 is a fragmentary cross-sectional view of the hydraulic networks.

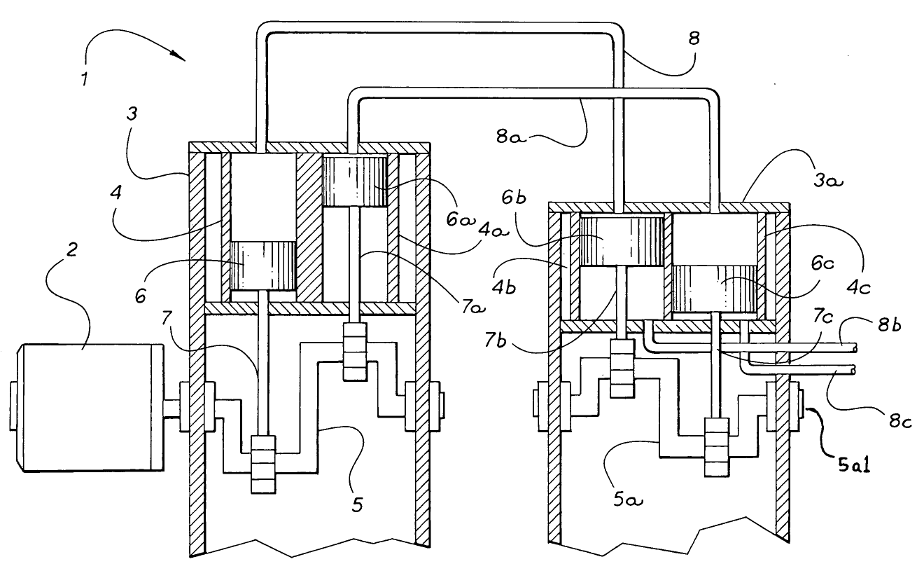

### DETAILED DESCRIPTION OF PREFERRED EMBODIMENT(S)

Referring now to the drawing, wherein like reference numerals designate corresponding structure throughout the view, a system and method 1 that is constructed according to a preferred embodiment of the invention includes a motor 2 with a plurality of hydraulic networks 3, 3a attached thereto. The hydraulic networks 3,3a are constructed as to incorporate cylinders 4, 4a, 4b, 4c, rotating mechanisms 5, 5a, and pistons 6, 6a, 6b (increased diameter), 6c (increased diameter), rods 7, 7a, 7b, 7c, and sealed lines 8,8a.

The motor 2 turns the rotating mechanism 5 of the primary hydraulic network 3 which causes the pistons 6, 6a, 6b, 6c to move fluid in and out of the cylinders through sealed lines 8,8a, thus causing rotation of the secondary hydraulic network at an exponentially greater force due to the increased pistons 6b, 6c size.

It is to be understood that all aspects of the hydraulic networks are proportionately sized in order to satisfy the Laws of Physics (ex. Conservation of energy). Also, even though numerous characteristics and advantages of the present invention have been set forth in the foregoing description, together with details of the structure and function of the invention, the disclosure is illustrative only, and changes may be made in detail, especially in the maters of shape, size and arrangement of parts within the principles of the invention to the full extent indicated by the broad general meaning of the terms in within the appended claims are expressed.

1. A system and method of increasing the output energy of a motor by transferring the output energy through a plurality of hydraulic networks of increasing piston diameter and decreasing cylinder height, whereas the final output energy is utilized as the primary source to drive a vehicle.

2. A motor in claim 1 is directly or indirectly mounted to a rotational mechanism contained within the makeup of a primary hydraulic system.

3. The rotational mechanisms in claim 2 contain a shaft/vanes or crankshaft/rods/pistons combination.

4. The crankshaft/pistons/rods combinations in claim 3 are configured in such a manner as to create rotation of the crankshafts when the fluid within the system is applied a force from the motor in claim 1.

5. The crankshafts in claim 1 share the same rotational angle and the stroke decreases outward from the primary hydraulic network.

6. The motor in claim 1 rotates the shaft of the primary hydraulic system which causes fluid to be pushed in and out of a secondary hydraulic system of increase size, in turn causing rotation of the secondary shaft with exponentially greater force.

7. The output energy in claim 1 is transferred from the secondary hydraulic network to another hydraulic network by way of interconnecting fluid-containing passages from piston to piston or crankshaft coupling.

8. The increase in output energy in claim 1 can be achieved by transferring said output energy through any plurality of hydraulic networks, whereas the final output energy is utilized as the primary energy source to drive a vehicle or equipment that requires a motor to operate.

9. The input energy in claim 1 in which to be transferred through the hydraulic networks can be of various forms of kinetic energy such as wind or fluid motion, in order to achieve an applicable operational system.

10. A camshaft/lever system or network can be implemented within the system in claim 1 to increase the efficiency of the entire system thereof.
